(19) United States
(12) Patent Application Publication
(10) Pub. No.: US 2016/0340263 A1
(43) Pub. Date: Nov. 24, 2016

(54) METHOD AND SYSTEM FOR SONIC-ASSISTED PRODUCTION OF FERTILIZERS

(71) Applicant: Dundee Sustainable Technologies Inc., Montreal (CA)

(72) Inventors: Jean-Marc Lalancette, Sherbrooke (CA); Bertrand Dubreuil, Trois-Rivieres (CA); David Lemieux, Thetford Mines (CA)

(21) Appl. No.: 14/719,776

(22) Filed: May 22, 2015

(51) Int. Cl. C05D 1/02; C01B 25/30; C01B 25/45; C05B 7/00

(52) U.S. Cl. CPC C05D 1/02; C05B 7/00; C01B 25/30; C01B 25/451

(57) ABSTRACT

A method for producing potassium-based fertilisers, comprising using potassium acid sulfate as the potassium source, and using sonication in reactions with magnesium silicate or apatite at low temperature, with near quantitative yield, to yield in times of the order of minutes the corresponding potassium magnesium sulfate or potassium di-hydrogen phosphate respectively.

### FIELD OF THE INVENTION

The present invention relates to fertilizers. More specifically, the present invention is concerned with a method and a system for sonic-assisted production of fertilizers.

### BACKGROUND OF THE INVENTION

Potassium is an essential component in fertilizers. The most abundant source of potassium is potassium chloride (KCl), sometimes referred to as potash. However in the case of intensive cultures, which typically require repeated applications of fertilizers, potassium chloride as such cannot be used because of the associate chloride that can sterilize the soil if present in too large amounts. In those circumstances, potassium sulfate (K₂SO₄) rather than potassium chloride (KCl) is used.

Magnesium is also an element required by some cultures, such as tobacco, potatoes or corn for example. With such crops, it has been found useful to use a naturally occurring mixed sulfate of potassium and magnesium such as langbeinite (K₂SO₄.2MgSO₄), known as SOPM. However, the increased uses of SOPM, along with the depletion of natural sources of this naturally occurring mineral, have led to using a synthetic potassium sulfate mixed with magnesium sulfate so as to duplicate the naturally occurring SOPM.

Another important agronomic element is phosphorus. A source of phosphorus is a fluorophosphate of calcium (Ca₅(PO₄)₃F) referred to as apatite, which cannot be used as a fertilizer because of its insolubility. However, treatment with sulfuric acid removes some calcium from the apatite and the resulting mixture of calcium monobasic phosphate, Ca(H₂PO₄)₂ and gypsum is then a convenient source of agronomic phosphorus, referred to as superphosphate. More refined sources of phosphorus can be obtained with pure phosphoric acid. However, this acid is very costly because of the complexity of its preparation, either from acid treatment of apatite or via the reduction of apatite to elemental phosphorus, followed by oxidation to P₂O₅ and hydrolysis. Potassium salts of phosphoric acid can be prepared using phosphoric acid and a source of potassium such as potash (KCl). But the reaction is difficult and generates mixtures of hydrochloric and hydrofluoric acids along with other undesirable substances. For these reasons as well as due to the high priced phosphoric acid, the end product is too costly for agronomic uses.

There is still a need in the art for a method for producing fertilizers.

### SUMMARY OF THE INVENTION

More specifically, in accordance with the present invention, there is provided a method for the production of a potassium-based fertilizer, comprising reacting a source of magnesium or phosphorus with potassium acid sulfate in a slurry submitted to sonication.

There is further provided a method for the production of mono- or di-potassium phosphate by reacting, under sonication, apatite with potassium acid sulfate in a slurry.

There is further provided a method for the production of sulfate of potassium and magnesium by reacting, under sonication, magnesium silicate with potassium acid sulfate solution in a slurry.

There is further provided a method for the production of potassium ammonium phosphate, comprising reacting a source of phosphorus with potassium acid sulfate in a slurry submitted to sonication, yielding monopotassium phosphate, and reacting the resulting monopotassium phosphate with ammonia.

There is further provided a method, comprising: a) producing potassium acid sulfate by reacting potash with sulfuric acid; b) recovering hydrochloric acid produced during step a); and c) reacting a source of magnesium or phosphorus with the potassium acid sulfate in a slurry submitted to sonication, thereby producing a potassium-based fertilizer.

Other objects, advantages and features of the present invention will become more apparent upon reading of the following non-restrictive description of specific embodiments thereof, given by way of example only with reference to the accompanying drawings.

### DESCRIPTION OF EMBODIMENTS OF THE INVENTION

The present invention is illustrated in further details by the following non-limiting examples.

Potassium acid sulfate (KHSO₄) is produced by the treatment of potash (KCl) with sulfuric acid (H₂SO₄), according to reaction 1 below, by substitution of the first hydrogen of sulfuric acid (H₂SO₄) with potassium, yielding potassium acid sulfate (KHSO₄), at a temperature comprised within the range between 120 and 130° C. Interestingly, hydrochloric acid (HCl) is also produced, which may be recovered as a secondary sellable product.

KCl+H₂SO₄→KHSO₄+HCl (1)

Potassium acid sulfate (KHSO₄) is then used for producing fertlisers such as monobasic potassium phosphate and SOPM, according to reactions (2) and (3) below.

Reaction 2 below describes the reaction of potassium acid sulfate (KHSO₄) with apatite:

3KHSO₄+2H₂SO₄+Ca₅(PO₄)₃F+10H₂O→3KH₂PO₄+5CaSO₄.2H₂O+HF (2)

Reaction 3 below describes the reaction of potassium acid sulfate (KHSO₄) with magnesium silicate:

2KHSO₄₊₂(3MgO.2SiO₂.2H₂O)+H₂SO₄→4(MgO.SiO₂)+K₂SO₄.2MgSO₄+6H₂O (3)

These reactions were performed at near ambient temperature, i.e. at a temperature comprised in a range between 10° C. and 50° C., under atmospheric pressure and with a content of solid mineral in the slurry of mixed potassium acid sulfate and sulfuric acid (KHSO₄/H₂SO₄) comprised in a range between 10 and 40% w/w. By submitting the reactants to sonication during the reactions, yields of the order of 95 to 99% of desired products, i.e. monobasic potassium phosphate and SOPM respectively, after contact times as short as one minute, were obtained.

Sonication of the reactants during the reactions can be achieved by using ultrasonic piezogenerators or mechanically by hydrodynamic cavitation. Both methods were tested successfully, to generate micro-bubbles in the reacting slurry either by immersing a sonic probe or by generating cavitation in the reacting slurry. The resulting soluble fertilizing elements, i.e. monobasic potassium phosphate (KH₂PO₄) in the case of reaction 2 and SOPM (K₂SO₄.2MgSO₄) in the case of reaction 3, can be isolated by filtration and separation from residual insoluble products reactions 2 and 3 respectively, i.e. gypsum and magnesium silicate respectively.

Crystallization allows obtaining pure monobasic potassium phosphate and pure SOPM respectively. In some cases, the produced monobasic potassium phosphate and SOPM are used as concentrated solutions rather than solids.

In the case of monobasic potassium phosphate (KH₂PO₄), the second proton on the phosphate group can be combined with ammonia (NH₃) to produce potassium ammonium phosphate as described by reaction 4 below:

KH₂PO₄+NH₃→K(NH₄)HPO₄ (4)

Dibasic potassium phosphate (K₂HPO₄) may be obtained with sonic treatment of apatite using a larger amount of potassium acid sulfate as described by reaction 5 below:

6KHSO₄+1.5Ca(OH)₂+Ca₅(PO₄)₃F+9H₂O→3K₂HPO₄+6CaSO₄.2H₂O+0.5CaF₂ (5)

The results of the reactions of potassium acid sulfate (KHSO₄) with magnesium silicate and with apatite were unexpected. Indeed, standard methods use concentrated sulfuric acid (H₂SO₄) and conditions of high temperature and/or pressure. Potassium acid sulfate (KHSO₄) being a relatively very weak acid when compared to sulfuric acid (H₂SO₄), it was not an acid that was contemplated in the art.

As known in the art, due to the significant difference between the ionization constants K₁ and K₂ of the two hydrogens of sulfuric acid (H₂SO₄), with K₁=4×10⁻¹ and K₂=1.2×10⁻², involving the second hydrogen of sulfuric acid (H₂SO₄) in a combination with potassium to yield potassium sulfate (K₂SO₄) from potash (KCl) is more difficult. Thus potassium sulfate (K₂SO₄) is produced under severe conditions, mainly using the Mannheim process, which is the reaction of potassium chloride with concentrated sulfuric acid at high temperatures, typically of at least 500° C.

Similarly, in the reaction between sulfuric acid (H₂SO₄) and magnesium silicate (3MgO.2SiO₂.2H₂O) to yield magnesium sulfate (MgSO₄), obtaining a full substitution of both hydrogens of sulfuric acid (H₂SO₄) by magnesium typically requires pressure leaching of the silicates at a temperature of at least 200° C.

Sulfatation of apatite (Ca₅(PO₄)₃F) with sulfuric acid (H₂SO₄) also requires high temperatures.

Since potassium acid sulfate (KHSO₄) is a relatively very weak acid when compared to sulfuric acid (H₂SO₄), considering that conditions of high temperature and/or pressure are required for reacting a mineral such as magnesium silicate or apatite with sulfuric acid (H₂SO₄) as described hereinabove, it was not expected that substituting potassium acid sulfate (KHSO₄) to sulfuric acid (H₂SO₄) in these reactions would facilitate these reactions.

The present invention provides a method for producing chloride-free fertilisers, comprising reacting potassium acid sulfate with a source of magnesium or phosphorus in a slurry submitted to sonication during a time of the order of the minute, i.e. comprised in a range between 30 s and 2 minutes.

By blending of the products of reactions 2-5 above, namely, monobasic potassium phosphate, SOPM, potassium ammonium phosphate and dibasic potassium phosphate, all obtained under very mild conditions and fast rates as described hereinabove, fertilizers adapted to the nature of the corps and the properties of the soils, free of undesirable elements such as chlorine and non-soluble product such as gypsum, are produced, at lower costs than existing methods.

Without limitation to the scope of the method, the following examples illustrate the implementation of the present invention.

First, potassium acid sulfate may be produced as per reaction 1 hereinabove. One mole of potassium chloride (74.56 g) was placed in a one-liter reaction flask and one mole of 98% sulfuric acid (100.0 g) was added to it in the flask over a period of half an hour. There was an evolution of hydrochloric acid, which was cooled in a condenser and adsorbed in 200 ml of water cooled to a temperature in a range between 0 and 2° C. After addition of the sulfuric acid, the temperature of the reaction flask was raised to a temperature in a range between 120 and 130° C. in a sand bath and was maintained in this temperature range while 100 ml of water was added slowly, i.e. over a period of two hours, to the system in the reaction flask. The distillate resulting from this water addition was then combined to the 200 ml of cold water and the HCl content was determined by titration, 35.9 g of HCl or 98.4% of the expected acid being thus recovered. The residual solid in the reactor was potassium acid sulfate, 136.5 g.

### Example 1

### Production of SOPM (Reaction 3)

To a solution of 0.2 mole of potassium acid sulfate KHSO₄ (27.2 g), 0.1 mole of sulfuric acid (10.0 g of H₂SO₄, 98%) in 200 ml of water in a 300 ml beaker, was added 100 g of hydrated magnesium silicate (serpentine: 3MgO.2SiO₂.2H₂O) 100% minus 60 mesh. This slurry was stirred at a temperature in a range between 25 and 50° C. while being submitted to a sonic treatment at 24 KHz for a period of 15 minutes, using a Hielscher apparatus, model 400S with a 7 mm titanium probe, 75% power setting. The reaction mixture was then filtered, washed with water and the combined washing and filtrate was evaporated and recrystallized in water. The solid 40.9 g was submitted to elemental analysis and corresponds to the formulation K₂SO₄.2MgSO₄, a mixed sulfate of potassium and magnesium known as langbeinite or SOPM. The potassium recovery in the form of langbeinite was 98.5%.

### Example 2

### Preparation of Potassium Phosphates (Reactions 2, 4, 5)

Potassium acid sulfate, 0.3 mole, 40.8 g, was dissolved in 200 ml of water along with 0.2 mole, 20 g, of 98% sulfuric acid. In this solution, in a 300 ml beaker, 50.4 g of apatite (0.1 mole) was slurried by stirring at 25-50° C. Then sonication was applied, using the Hielscher equipment described in Example 2. After a 15-minutes contact under sonication, the mixture was filtered, and the solid was rinsed with water. The solution was submitted to elemental analysis for potassium, phosphates and sulfates. The results indicated that reaction had involved 13% of the potassium as K₂HPO₄, 84.4% of the potassium as KH₂PO₄ and only 2.6% as non-reacted KHSO₄. Therefore, this conversion of potassium acid sulfate to potassium phosphates is 97.4%. A 100 ml solution of mono potassium phosphates (13.6 g, 0.1 mole) treated with 0.5 mole of ammonium hydroxide (17 g NH₄OH) in 150 ml of water. Upon evaporation, the residual solid, 14.9 g, indicated a near-complete (97%) transformation of KH₂PO₄ into K(NH₄)HPO₄ as per the elemental analysis.

### Example 3

### Production of SOPM (Reaction 3)

In a solution of 272.3 g of KHSO₄ and 100.0 of H₂SO₄ in 3 l of water, 554.22 g of magnesium silicate (serpentine, 3MgO.2SiO₂.2H₂O) was slurried at 5000 while being submitted to sonication by hydrodynamic cavitation (RAPS Technology System). Sampling at five minutes periods indicated that the reaction was completed after less than 5 minutes.

A one-liter aliquot of the treated material was filtered and the filtrate evaporated to dryness. The elemental analysis for K, Mg, and S indicated the presence of the expected product, K₂SO₄.2MgSO₄, 137.0 g or 99% yield. Upon recrystallization, leonite (K₂SO₄.MgSO₄) was obtained.

### Example 4

### Production of Phosphate of Potassium (Reaction 2)

In a solution of 408.5 g of KHSO₄ (3 moles) and 200 g of H₂SO₄ 98% (2 moles) in 3 liters of water was slurried 504.3 g of apatite (Ca₅(PO₄)₃F, one mole) at 45° C. while being submitted to sonication by hydrodynamic cavitation (RAPS Technology System). Samplings after 2 minutes periods indicated that the reaction was completed after about one minute; in fact, after 30 seconds 90% of the phosphorus was already in solution to give monobasic potassium phosphate (KH₂PO₄) with a slight excess of free phosphoric acid.

It was thus shown that by using sonic treatment, potassium acid sulfate could be reacted very rapidly at low temperature with near quantitative yield with magnesium silicate and apatite, to give the corresponding potassium magnesium sulfate or potassium di-hydrogen phosphate respectively.

There is thus provided a method for producing potassium salts, either sulfate (see reaction 3 above) or phosphate (see reactions 2, 4, 5 above), that can incorporate one or more other agronomic elements such as phosphorus, nitrogen, magnesium and sulfur, these potassium salts being deprived of adverse elements such as chloride, or insoluble components such as gypsum. There is thus provided a method for producing useful fertilizers, fairly soluble in water as required by intensive cultures such as aquaculture or drop watering.

There is provided a method for producing a chlorine-free mixed sulfate of potassium and magnesium (see reaction 3 above) or a phosphate of potassium (see reactions 2, 4, 5 above) free of insoluble material, by using potassium acid sulfate as the source of potassium. The method comprises reacting, under sonic treatment, potassium acid sulfate with a source of magnesium, such as magnesium silicate for example, or with a source of phosphorus, such as apatite for example, to obtain a mixed sulfate of potassium and magnesium (K₂SO₄.2MgSO₄) or potassium phosphate (KH₂PO₄) respectively. Under sonic treatment during the reactions, potassium acid sulfate yields fast and complete reaction with these minerals, at near ambient temperature and under atmospheric pressure, opening a new and much simplified access to mixed sulfate of potassium and magnesium, or phosphate of potassium.

There is thus provided a method for production of potassium-based fertilizers by a sonication-assisted reaction of potassium acid sulfate with a source of magnesium or phosphorus.

The source of magnesium may be a finely ground magnesium silicate, i.e. ground to 40-100 mesh, for example to 50 mesh.

The source of phosphorus may be a finely ground, i.e. ground to 40-100 mesh, for example to 50 mesh, phosphate of calcium, i.e. apatite.

The sonic assistance may be provided using an ultrasonic piezogenerator or by hydrodynamic cavitation.

The reaction is conducted in a temperature range comprised between 10 and 50° C., under atmospheric pressure, in a water slurry.

There is provided a method for the production of mono or dipotassium phosphate by reacting, under sonic treatment, a potassium acid sulfate solution with apatite slurried in the acidic solution. There is further provided a method for the production of potassium ammonium phosphate by reaction of the produced monopotassium phosphate with ammonia.

There is provided a method the production of SOPM by reacting, under sonic conditions, a potassium acid sulfate solution with magnesium silicate slurried in the acidic solution

The scope of the claims should not be limited by the embodiments set forth in the examples, but should be given the broadest interpretation consistent with the description as a whole.

1. A method for the production of a potassium-based fertilizer, comprising reacting a source of magnesium or phosphorus with potassium acid sulfate in a slurry submitted to sonication.

2. The method as in claim 1, wherein the source of magnesium is a magnesium silicate.

3. The method as in claim 1, wherein the source of phosphorus is a phosphate of calcium.

4. The method as in claim 1, wherein the slurry is submitted to sonication using an ultrasonic piezogenerator.

5. The method as in claim 1, the slurry is submitted to sonication by hydrodynamic cavitation.

6. The method as in claim 1, wherein said reaction is conducted at a temperature comprised in a range between 10 and 50° C., at atmospheric pressure, in a water slurry.

7. The method of claim 1, wherein a content of solid mineral in the slurry is comprised in a range between 10 and 40% w/w.

8. The method of claim 1, comprising submitting the slurry to sonication during a time comprised in a range between 30 s and 2 minutes.

9. The method of claim 1, for producing mono- or di-potassium phosphate, the source of phosphorus being apatite.

10. The method of claim 1, for producing sulfate of potassium and magnesium, the source of magnesium being a magnesium silicate.

11. The method of claim 1, comprising reacting apatite as a source of phosphorus with potassium acid sulfate in a slurry submitted to sonication, yielding monopotassium phosphate, the method further comprising reacting the resulting monopotassium phosphate with ammonia, yielding potassium ammonium phosphate.

12. A method for the production of mono- or di-potassium phosphate by reacting, under sonication, apatite with potassium acid sulfate in a slurry.

13. A method for the production of sulfate of potassium and magnesium by reacting, under sonication, magnesium silicate with potassium acid sulfate solution in a slurry.

14. A method for the production of potassium ammonium phosphate, comprising reacting a source of phosphorus with potassium acid sulfate in a slurry submitted to sonication, yielding monopotassium phosphate, and reacting the resulting monopotassium phosphate with ammonia.

15. A method, comprising:
a) producing potassium acid sulfate by reacting potash with sulfuric acid;
b) recovering hydrochloric acid produced during step a); and
c) reacting a source of magnesium or phosphorus with the potassium acid sulfate in a slurry submitted to sonication, thereby producing a potassium-based fertilizer.
